(19) United States
(12) Patent Application Publication
(10) Pub. No.: US 2010/0089927 A1
(43) Pub. Date: Apr. 15, 2010

(54) Pressurised gas container

(75) Inventor: Thomas Rassloff, Lubek (DE)

Correspondence Address: MCGLEW & TUTTLE, PC, P.O. BOX 9227, SCARBOROUGH STATION, SCARBOROUGH, NY, 10510-9227, US

(73) Assignee: Drager Aerospace GmbH, Lubeck (DE)

(21) Appl. No.: 11/226,783

(22) Filed: Sep. 14, 2005

(30) Foreign Application Priority Data
Sep. 15, 2004 (DE) 10 2004 044 541.9

(51) Int. Cl. F17C 1/06; F17C 13/12

(52) U.S. Cl. 220/560.01; 220/586; 220/590

(57) ABSTRACT

A pressurized gas container is provided with a rigid inner container and with a projectile-proof casing. The projectile-proof casing surrounds the inner container on the outside and is of an elastic material having a high tensile strength in the peripheral direction.

### CROSS REFERENCE TO RELATED APPLICATIONS

This application claims the benefit of priority under 35 U.S.C. §119 of German Patent Application DE 10 2004 044 541.9 filed Sep. 15, 2004, the entire contents of which are incorporated herein by reference.

### FIELD OF THE INVENTION

The present invention relates to a pressurized gas container.

### BACKGROUND OF THE INVENTION

Pressurized gas containers are applied in aircraft for storing oxygen for example, and particular demands are placed on these. Thus there are relevant regulations with regard to the projectile-resistance of pressurized gas containers in aircraft. The pressurized gas containers in the form of composite containers which have existed up to now however only fulfill these regulations to an unsatisfactory extent, or have other disadvantages.

For reasons of weight, one often applies composite pressurized gas containers in aircraft, which comprise a carrier or inner body of metal, for reasons of weight most of aluminum, which is wrapped around by several layers of glass fibers and/or carbon fibers which are embedded in resin. These composite containers display a large fragmentation and splitting behavior when under fire. Furthermore, the bursting behavior causes a particularly rapid and complete release of the pressurized gas contents with a corresponding, high-energy pressure wave. At the same time, there additionally exists the danger of powerful combustion effects depending on the type of pressurized gas.

Recently, a pressurized gas bottle for medical oxygen has become known, which comprises an inner body of brass as well as a reinforced carbon fiber resin coating, for suppressing the combustion effects. This pressurized gas container however has a large weight, a high price and a limitation of the filling pressure with regard to the demands on the projectile-resistance. As such this container indeed offers no advantages with respect to known pressurized gas containers of steel, which likewise have a high weight, but which on the other hand are considerably less expensive.

### SUMMARY OF THE INVENTION

It is therefore the object of the invention to provide an improved pressurized gas container which has an improved projectile-resistance with a low weight, and preferably is also capable of avoiding the loss of the container contents when under fire.

The pressurized gas container according to the invention comprises a gas-tight, preferably pressure-tight inner container accommodating the pressurized gas, and a projectile-proof casing surrounding this on the outer side. With this, the projectile-proof casing consists of a material which on the one hand is elastic and on the other hand has a high tensile strength in the peripheral direction or surface direction. The material has the high tensile strength in the direction of extension of the casing parallel to the outer wall of the inner container. The rigid inner container may be manufactured for example of metal, in particular aluminum or steel. The elastic casing has the effect that the movement energy of projectiles is accommodated by the deformation of the casing, or may be diverted in the peripheral direction. The high tensile strength of the material in the peripheral direction at the same time prevents the bursting of the casing and thus of the whole pressurized gas container. A destruction and in particular a leakage of the inner container may be prevented by the projectile-proof casing, since the largest part of the projectile energy is accommodated or absorbed by the casing. This is possible due to the given elasticity and simultaneously high tensile strength of the casing, so that this under fire does no burst immediately as known jacketings of carbon fires or glass fibers which are embedded in resin.

The inner container is preferably formed as a composite container. The use of a composite container has the advantage of a minimization of weight of the whole pressurized gas container. With this, the composite container in the known manner may consist of a metallic carrier, preferably of aluminum, and a wrapping of carbon fibers and/or glass fibers which are embedded in resin. The projectile-proof casing of the high tensile strength and simultaneously elastic or extensible material is arranged around this composite container. This has the effect that the projectile-proof casing accommodates the projectile energy, which prevents a bursting on account of its high tensile strength. When under fire, the composite container lying at the inside then only needs to accommodate slight surface loads, so that a bursting and a penetration of the composite container are prevented. Thus one may succeed in preventing pressurized gas from exiting the pressurized gas container when under fire, by which means a pressure wave and also combustion effects are avoided.

The casing of elastic and high tensile strength material is arranged particularly preferably distanced to the outer surface of the inner container. By way of this, when under fire, a radial movement of the casing to the inside is rendered possible, without the inner container being directly damaged or deformed. Thus the casing is only given room to deform in order to be able to accommodate the movement energy of the projectile. The distance between the inner container and the casing is preferably between 20 and 30 mm, but may also be selected larger or smaller depending on the size of the container and the demands with regard to the projectile-resistance. The distance also depends on which maximal deformation of the inner container is permissible. The greater is the distance selected, the smaller becomes the deformation of the inner container due to the deforming casing when under fire.

The free space between the inner container and the casing is preferably filled with a yielding material. This material to the first extent serves for ensuring the defined distance between the inner container and the casing, so that these may not dislocate relative to one another. Furthermore, the yielding material in the free space may likewise serve for accommodating the energy when under fire, in order to absorb the projectile energy. The yielding material at the same time protects the inner container from damage when the elastic casing deforms inwards in the radial direction when under fire.

The yielding material is preferably a foam material, for example a hard foam material. Such a material has a low weight, is shape-stable and may, as mentioned above, protect the inner container on deformation of the elastic casing. Furthermore such a material in fluid form may be easily injected into the free space between the outer and inner container, and thus the free space may be foamed out.

The elastic casing which surrounds the inner container usefully contains a fiber material, preferably in the form of a woven material. With this, the fibers in an ideal manner are aligned such that they may accommodate the tensile forces in all peripheral or extension directions of the casing, so that a tearing or bursting of the casing is prevented when under fire. The fibers or the woven material may be deposited in several layers depending on the demands with regard to the projectile resistance, in order to achieve a greater strength. With this, the fibers of the different layers preferably run at different directions in order to be able to accommodate the forces in all surface directions in the peripheral direction of the casing. The fiber or woven material layers when under fire intercept the projectile and on account of the deformation of the casing, distribute the largest part of the forces onto the fibers in the transverse direction to the perpendicular of the impact surface, so that the force acting on the inner container is minimized. The resilience of the impact surface which is required for this is achieved by way of the elasticity of the material of the casing, i.e. of the fibers or of the woven material.

The fiber material is preferably embedded into a resin. I.e. the individual fibers or fiber layers or woven material layers are embedded into resin or into a resin matrix for the purpose of fixation, processing ability and shape stability. A phenol resin may for example form the resin matrix. The resin or resin matrix is usefully matched to the fiber material with regard to its elongation at break, so that the composite material of fiber material and resin has the demanded strength properties of the casing for achieving the projectile resistance.

The fiber material preferably comprises artificial fibers of an adequate strength and a suitable elasticity. Artificial fibers offer a high tensile strength with a simultaneously higher elongation at break than mineral fibers such as carbon fires or glass fibers.

These may for example be artificial fibers of aromatic polyimides (aramide) which are obtainable under the trademark KEVLAR. These fibers have a very low weight, a very high tensile strength and simultaneously a sufficient elasticity so that the casing may have an adequate ductility in order to intercept the projectile.

Alternatively or additionally to this, the casing may comprise artificial fibers of PBO (polyphenlyene-2,6-benzobisoxazole) which are obtainable on the market under the trademark ZYLON. This material has a tensile strength which is even greater than aramide, but however likewise offers the elasticity which is required for the projectile-resistance of the casing.

Furthermore, the casing alternatively or additionally may comprise artificial fibers of high-strength polyethylene which likewise offers a high tensile strength and adequate elasticity.

Apart from the previously mentioned materials, one may also apply other suitable materials, in particular fibers or woven material which have a very high tensile strength with a simultaneous elasticity or extensibility. The fiber or woven material is arranged in the casing in an adequate number of layers depending on the demands on the projectile resistance, in order to be able to accommodate or divert forces in the peripheral or surface section occurring when under fire, and thus to protect the inner container containing the pressurized gas from an excessive force effect.

It is further preferable to design the pressurized gas container such that the inner container may be removed form the projectile-proof casing. This allows the projectile-proof casing to be offered as a separate component into which a pressurized gas container as an inner container and which is available on the market may be inserted. This design furthermore has the advantage that the inner container may be removed from the casing for pressure inspections which are required at regular intervals. For this, the projectile-proof casing is for example designed in an essentially tubular manner, wherein one end-surface of the tube is designed closed and the other opened, so that the pressurized gas container may be inserted through the opened surface into the casing. The opened side may then additionally be closed with a cap. Preferably the tube is designed so long that peripherally it also surrounds the valve of the inner container. An elastic material which fills the intermediate space between the casing and the inner container, as has been described above, is preferably firmly connected to the projectile-proof casing with this design. I.e. the yielding material lines the inner surfaces of the casing which come into contact with the inner container.

The invention further relates to a projectile-proof casing for a pressurized gas container. Such a projectile-proof casing according to the invention may, as previously described, be arranged around a pressurized gas container available on the market, in particular a composite pressurized gas container, in order to render the pressurized gas container projectile-proof. The projectile-proof casing according to the invention is designed of an elastic material which has a very high tensile strength in the peripheral direction, as described above on account of the complete pressurized gas container. The casing is preferably divided and is designed open at one side, so that the pressurized gas container may be applied into the casing. With this one may provide a cap which closes the remaining opening after inserting the pressurized gas container.

A yielding material, for example a foam material is particularly preferably arranged on the inner side of the casing which faces the pressurized gas container. With this, the yielding material is usefully firmly connected to the surrounding casing. The yielding material when the pressurized gas container has been inserted, fills the space between the outer walls of the pressurized gas container and the material of the casing which has a high tensile strength, as described above.

The projectile-proof casing preferably comprises a fiber material which further preferred is formed of artificial fibers. These, as described above, may be artificial fibers of aromatic polyimides (aramide), of PBO or of high-strength polyethylene.

Otherwise, the projectile-proof casing which is provided as a separate component may be designed in each manner which has been described above by way of the pressurized gas container.

The invention is hereinafter described by way of example and by way of the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectioned view of a first embodiment of the invention; and

FIG. 2 is a sectioned view of a second embodiment of the invention.

### DESCRIPTION OF THE PREFERRED EMBODIMENTS

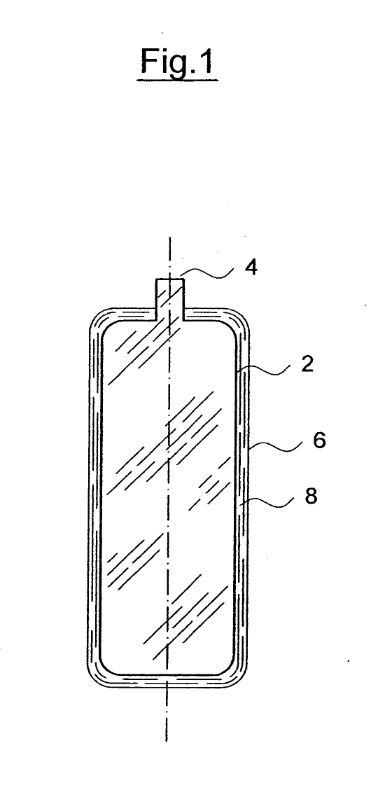

Referring to the drawings in particular, FIG. 1 schematically shows a pressurized gas container according to the invention. The pressurized gas container comprises an inner container 2 which in the known manner may be designed as a composite container or metal container, for example of steel or aluminum. The inner container 2 furthermore in the known manner comprises an opening or a connection 4 for filling and for dispensing the pressurized gas located in its inside.

The inner container 2 is surrounded by a casing 6 which is distanced to the outer surface of the inner container 2 preferably over the entire periphery, so that a free space 8 is formed between the inner container 6 and the casing 8.

The casing 6 is formed of a material which on the one hand is elastic and on the other hand has a high tensile strength in the peripheral direction of the container, i.e. in the extension direction of the casing 6 parallel to the outer surface of the inner container. For this, the casing 6 preferably consists of several layers of a material which has a high tensile strength and is extensible, such as aramide or PBO, which are embedded into a resin matrix. However also other suitable materials may be applied. The number of layers in which the material is arranged depends on the mechanical properties of the applied fibers or of the applied woven material, as well as the required projectile-resistance. The fibers are arranged in the individual layers such that they extend where possible in all directions of extension of the casing, so that forces may be uniformly distributed in the casing 6 in all directions.

The elasticity of the casing permits this to be able to deform radially inwards, i.e. in the direction of the inner container 2, when under fire, and at the same time to divert the projectile energy or the impact force of the projectile in a direction transverse to the impact direction of the projectile into the direction of extension of the casing 6. The free space 8 between the inner container 2 and the casing 6 at the same time permits the deformation of the casing 6 without the container 2 having to deform or becoming damaged. The free space 8 is filled with a foam material in the form of a hard foam for an improved protection of the inner container 2.

The radial width of the free space 8 depends on how great the deformation of the casing 6 is when under fire, and the deformation which the inner container 2 permits without losing its pressure strength. I.e. if the inner container 2 is formed of a material, for example aluminum or steel which permits an adequate deformation without destruction, the distance between the casing 6 and the inner container 2 may be selected small, or one may completely do away with this distance. If the inner container 2 is designed such that it permits only a small deformation or none at all without damage, i.e. without a pressure loss, then the distance between the casing 6 and the inner container 2 is selected correspondingly larger, so that the deformation of the casing 6 is effected as completely as possible in the free space 8. This makes particular sense with the application of a composite container as an inner container 2 since such a container only permits slight deformations on account of the rigid sheathing with carbon fibers and/or glass fibers.

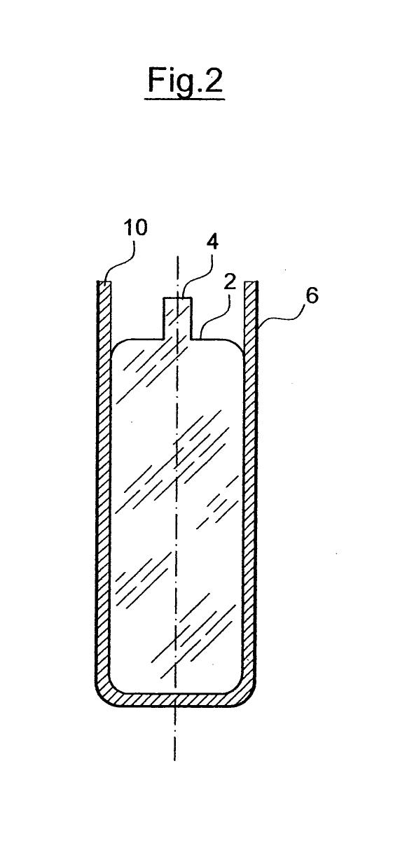

FIG. 2 schematically shows a second embodiment of the invention with which the projectile-proof casing 6 is designed as a separate component into which the inner container 2 is applied in a removable manner. The inner container 2 may be a known, standard available pressurized gas container, in particular a composite pressurized gas container. The casing 6, as with the casing 6 of the embodiment which has been described by way of FIG. 1, consists of a woven material or aramide or PBO which has a high tensile strength and is extensible. The woven material is embedded into a resin matrix, so that a composite material is formed which has a high tensile strength with a simultaneously high extension at breakage.

A yielding layer of a foam material 10 is arranged on the inner side of the casing 6 which faces the pressurized gas container 2. The foam material 10 in the shown example is firmly connected to the casing 6, but may also be applied into the casing in a removable manner. The foam material 10 fills the space between the outer wall of the pressurized gas container 2 and the casing 6, as explained by way of the free space 8 by way of FIG. 1.

With the embodiment according to FIG. 2, the peripheral walls of the casing 6 and the lining of foam material 10 connected to this are extended beyond the end-side of the pressurized gas container 2 to such an extent that they also surround and protect the connection 4 of the pressurized gas container 2 in a peripheral manner. Additionally, the open side of the casing may be closed with a cap which is not shown in FIG. 2. The pressurized gas container 2 may be inserted and removed through the opening of the casing 2, for example for the pressure strength tests which have been previously described.

While specific embodiments of the invention have been shown and described in detail to illustrate the application of the principles of the invention, it will be understood that the invention may be embodied otherwise without departing from such principles.

### APPENDIX

### List of Reference Numerals

2—inner container
4—connection
6—casing
8—free space
10—foam material

1. A pressurized gas container, comprising:
a gas-tight inner container;
a projectile-proof casing surrounding the gas-tight inner container on the outside, the projectile-proof casing being of a material which is elastic and which has a high tensile strength in the peripheral direction, wherein said casing is arranged at a spaced location from the outer surface of the inner container such that said casing and said outer surface of said inner container define a free space, said free space being filled with a yielding material, said yielding material being a foam material, said casing defining a means for absorbing energy from a projectile via radial deformation such that the projectile does not penetrate said casing, said foam material defining a means for receiving a radially deformed portion of said casing such that said inner container is not damaged via said radially deformed portion of said casing, wherein said foam material absorbs said energy from said projectile.

2. A pressurized gas container according to claim 1, wherein said inner container comprises a composite container.

3-5. (canceled)

6. A pressurized gas container according to claim 1, wherein the casing contains a fiber material including a woven material portion.

7. A pressurized gas container according to claim 6, wherein the fiber material is embedded into a resin.

8. A pressurized gas container according to claim 6, wherein the fiber material comprises artificial fibers.

9. A pressurized gas container according to claim 8, wherein at least some of the artificial fibers consist essentially of aromatic polyimides (aramide).

10. A pressurized gas container according to claim 8, wherein at least some of the artificial fibers consist essentially of PBO (polyphenlyene-2,6-benzobisoxazole).

11. A pressurized gas container according to claim 8, wherein at least some of the artificial fibers consist essentially of high-strength polyethylene.

12. A pressurized gas container according to claim 1, wherein the inner container is removable from the projectile-proof casing.

13. A projectile-proof casing for a pressurized gas tight container, the projectile proof casing comprising:
a pressurized gas tight inner container;
a casing structure applied about the pressurized gas tight inner container, the casing structure being formed of an elastic material which has a high tensile strength in the peripheral direction, said casing structure having a projectile proof outer surface, said projectile proof outer surface defining a means for absorbing energy from projectiles such that at least a portion of said projectile proof outer surface is in a radially deformed state with at least one projectile engaging said projectile proof outer surface, wherein projectiles cannot penetrate said projectile proof outer surface, wherein a yielding material is arranged on the inner side facing the pressurized gas container, said yielding material defining a means for absorbing energy produced with said at least one projectile engaging said projectile proof outer surface such that said yielding foam material radially deforms when said projectile proof outer surface is in said radially deformed state, wherein said energy from said at least one projectile is distributed over an area of said inner container via said yielding material without said inner container being damaged.

14. (canceled)

15. A projectile-proof casing according to claim 13, wherein the casing structure includes an artificial fiber material.

16. A pressurized gas container, comprising:
a gas-tight inner container having an outer surface;
a projectile-proof casing surrounding at least a portion of the outer surface of the gas-tight inner, the projectile-proof casing comprising an elastic material having a high tensile strength in a peripheral direction relative to the inner container, wherein the casing is arranged at a spaced location from the outer surface of the inner container to define a free space, said outer surface defining a means for absorbing energy from a projectile such that said outer surface deforms in a radially inward direction with at least one projectile engaging said casing, wherein said at least one projectile does not penetrate said casing;
a yield foam material, said free space being filled with said yielding foam material, said yielding foam material defining an energy absorption means for absorbing energy produced via the projectile engaging said projectile-proof casing, said yield foam material being in a deformed state when said casing is deformed in said radially inward direction, said energy from said at least one projectile being distributed over an area of said inner container via said yield foam material without deforming said inner container, said yielding material engaging said gas-tight inner container and said projectile-proof casing.

17. (canceled)

18. A pressurized gas container according to claim 1, wherein the casing contains a fiber material embedded into a resin.

19. A pressurized gas container according to claim 18, wherein the fiber material comprises artificial fibers.

20. A pressurized gas container according to claim 19, wherein the artificial fibers are formed of one or more material from the group consisting of aromatic polyimides (aramide), PBO (polyphenlyene-2,6-benzobisoxazole), and high-strength polyethylene.

21. A pressurized gas container according to claim 1, wherein the projectile does not penetrate the yielding material.

22. A projectile-proof casing according to claim 13, wherein the projectile does not penetrate the yielding material.

23. A pressurized gas container according to claim 16, wherein the projectile does not penetrate the yield foam material.
